(19) United States
(12) Patent Application Publication
(10) Pub. No.: US 2016/0320133 A1
(43) Pub. Date: Nov. 3, 2016

(54) PLANT AND METHOD FOR THE RECOVERY OF HEAT FROM A FIRING KILN

(71) Applicants: Gian Paolo BALDERACCHI, Rubiera (Reggio Emilia) (IT); Cosimo RUSCE, Rubiera (Reggio Emila) (IT); Primo RUINI, Casalgrande (Reggio Emilia) (IT); Enrico GIBERTINI, Reggio Emilia (IT)

(72) Inventor: Gian Paolo BALDERACCHI, Rubiera (IT)

(73) Assignees: Cosimo RUSCE, Rubiera (Reggio Emila) (IT); Primo RUINI, Casalgrande (Reggio Emilia) (IT); Enrico GIBERTINI, Reggio Emilia (IT)

(21) Appl. No.: 15/105,033

(22) PCT Filed: Nov. 25, 2014
(86) PCT No.: PCT/IB2014/066316

§ 371 Date: Jun. 16, 2016

(30) Foreign Application Priority Data
Dec. 20, 2013 (IT) MO2013A000353

(51) Int. Cl. F27D 17/00; F27B 9/30; F27B 9/24

(52) U.S. Cl. CPC F27D 17/004; F27B 9/24; F27B 9/3044; Y02P 40/65

(57) ABSTRACT

A plant (1) for the recovery of heat from an industrial firing kiln (2), comprising at least one primary circuit (11, 12) that includes at least an internal heat exchanger (13, 14), arrangeable in a cooling section of said kiln (2), in which a primary process liquid flows in said primary circuit (11, 12).

The present invention relates to a plant and a method for the recovery of heat from firing kilns in the ceramic industry.

The prior art includes firing kilns for tiles, masonry articles, porcelain and other ceramic items, which have one or more firing sections, downstream of which one or more cooling sections are arranged.

In detail, as it is known, a firing kiln can include the following cooling sections, in succession: rapid cooling zone, slow cooling zone, neutral zone and final rapid cooling zone.

In the cited cooling zones, the temperature of the ceramic articles is lowered by injection internally of the kiln of air coming from the outside or from the inside of the factories housing the kiln (typically a shed).

In detail, it is known the use of air/air exchangers which extend within the cooling zones, arranged below the upper vaults of the various cooling sections of the kiln.

The air exiting from these exchangers, which has a temperature approximately varying between 170° C. and 200° C. according to the section which it has been removed from, is then exploited to heat buildings or to supply dryers.

Though the above-illustrated known system is partially able to recover and reutilise the heat produced in the firing kilns, it is broadly inefficient.

In fact, the known system is able to recover only a minimum part of the heat transmitted or radiated in the cooling zones of the kiln, but the majority of this heat is dispersed and, therefore, not utilised.

For economic, energy-efficiency and environmental reasons, the need to develop a way of recovering more efficiently the heat dissipated in the cooling sections of the ceramic items has been felt for a long time.

The technical aim behind the present invention is therefore to provide a plant for the recovery of heat from a firing kiln which satisfies the above-cited need and obviates the drawbacks of the prior art.

Such technical aim is attained by a plant for the recovery of heat made according to claim 1 and by the method for the recovery of heat actuated according to claim 15.

Further characteristics and advantages of the present invention will more fully emerge from the indicative description given by way of non-limiting example of preferred but not exclusive embodiments of the plant of the invention, as illustrated in the accompanying drawings, in which:

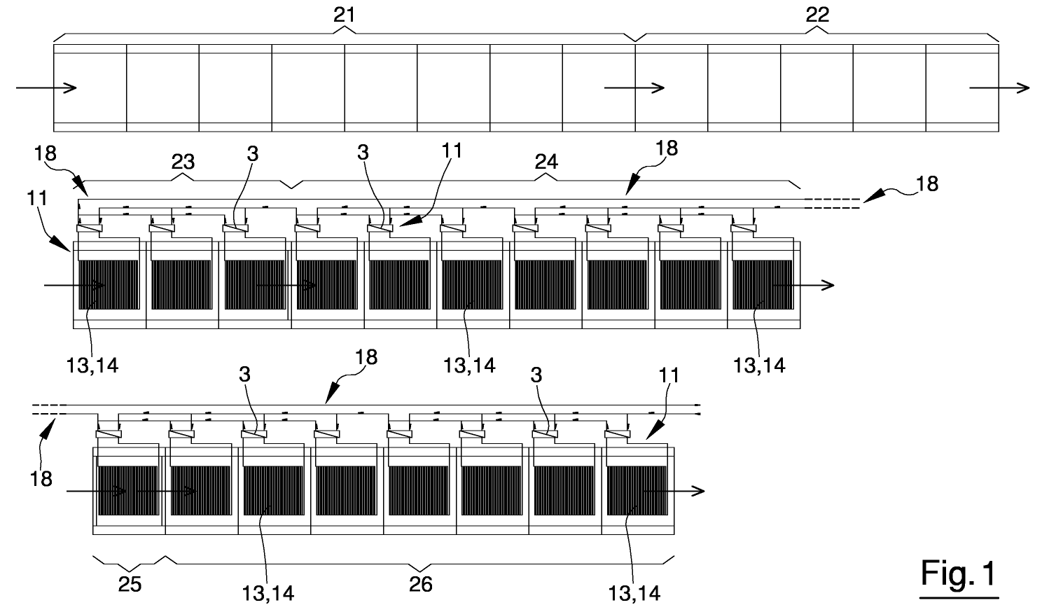

FIG. 1 is a schematic representation in plan view of a roller firing kiln, in which a plant according to the invention is implemented, sub-divided into three parts for reasons of clarity in the representation;

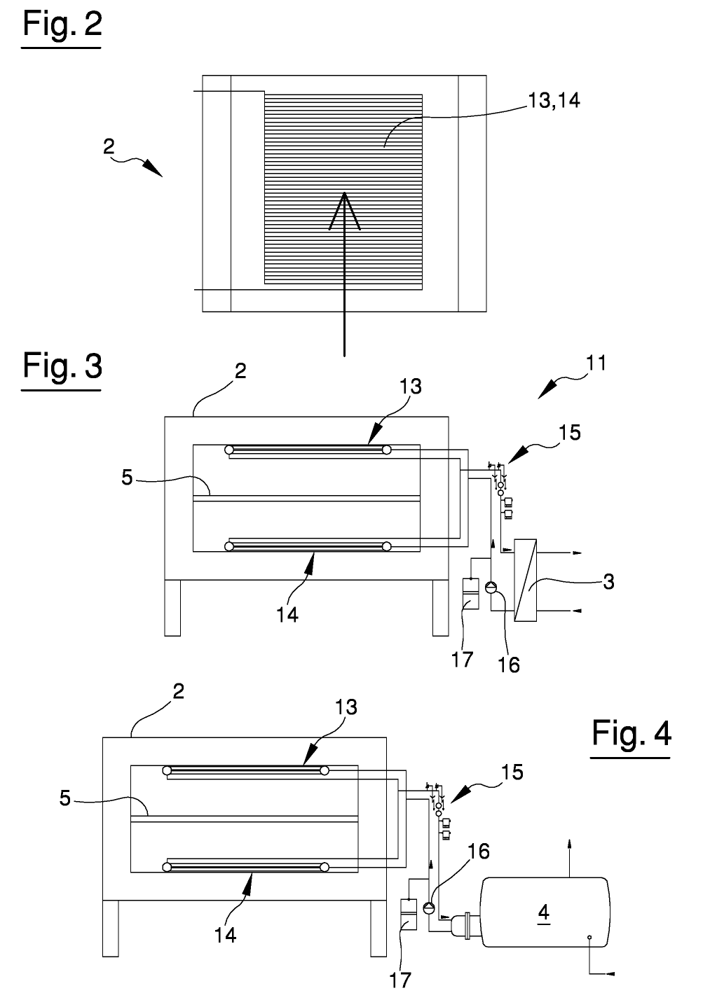

FIG. 2 is a schematic representation in plan view of a module of the kiln of FIG. 1; and

FIGS. 3 and 4 are schematic views in transversal section of the kiln of the preceding figures, to which two distinct embodiments of the proposed plant are applied.

With reference to the cited figures, 1 denotes in its entirety the plant of the invention.

The proposed plant 1 has been developed for the recovery of heat from a firing kiln 2 for the production of ceramic items, such as tiles, masonry articles, ceramic articles, etc.

In the following, for reasons of simplicity of description, reference will be made, without losing in terms of generality, to the preferred but non-limiting case of application of the invention to kilns 2 for the firing of ceramic items.

The kiln 2 has a usual longitudinal shape, for example defined by a plurality of modules aligned in succession, and comprises internally thereof a roller conveyor 5 (illustrated schematically in FIGS. 3 and 4) which supports and transports the ceramic items.

As shown in FIG. 1, a type of kiln 2 in which the proposed plant 1 can be applied comprises, in succession: a pre-kiln section (not illustrated), a pre-heating section 21, a firing section 22 provided with burners, a rapid cooling section 23, a slow cooling section 24, a neutral zone 25 and a final cooling section 26.

In its more general aspects, the proposed plant 1 comprises at least a primary circuit 11, 12 which comprises a respective internal heat exchanger 13, 14 destined to be arranged in one of the cooling sections of the kiln 2.

The plant 1 preferably comprises a plurality of primary circuits 11, 12, each provided with an internal heat exchanger or heat exchangers distributed along the longitudinal development of the cooling sections of the kiln 2.

In the present description, by the generalised term “cooling sections” are meant the terminal zone of the kiln 2 which includes the assembly of: the rapid cooling section 23, the slow cooling section 24, the neutral zone 25 and the final cooling section 26.

In a very important aspect of the invention, the plant 1 comprises a primary process liquid that flows in said primary circuit 11, 12, which can be constituted by superheated water following the passage in the heat exchanger, or by molten salts or by another suitable liquid.

Clearly the primary circuit 11, 12 comprises at least a delivery branch to carry the primary liquid into the internal exchanger 13, 14 located in the kiln 2 and a return branch to extract the liquid at a high temperature.

In the case of a modular kiln 2, the plant 1 can advantageously include a primary circuit 11, 12 for each module, consequently defining a modular plant 1.

Therefore, in accordance with the specific design or constructional requirements primary circuits 11, 12 can be installed, as a choice, only in some but not in all modules of the kiln 2.

Further, the primary circuits 11, 12 can work with the same primary liquid or can be provided with different primary liquids.

The internal exchanger 13, 14 can be of the tube bundle type, finned tube type or can be of another type.

The internal exchanger 13, 14 is preferably made of carbon steel or stainless steel or other suitable materials for the use destination thereof. Given that the cited primary liquid enables a much higher heat exchange performance than air, the plant 1 of the invention is able to extract heat from the cooling sections of the kiln 2 much more efficiently than the prior art.

In more precise terms, the internal heaters of the plant 1 are able to receive both the heat emanated by transmission and the heat radiated by the kiln 2 itself.

Note that as great quantities of heat are inevitably produced in kilns for firing ceramic items, and as it is necessary to lower the temperature of the ceramic items considerably before removing them from the kiln 2, the invention simultaneously attains two results.

On the one hand, heat is accumulated in the primary liquid which otherwise would be dispersed and wasted, and also the cooling process of the ceramic items is made more efficient and rapid.

As will be more fully detailed in the following, the heat collected by means of the plant 1 of the invention is used to reduce the energy requirements of the factories housing the firing kilns, with consequences in terms of economic savings and reduction of pollution.

In fact, these factories are notoriously energy-consuming and therefore expensive and, in the final, analysis, polluting; therefore, an efficient recovery of heat from the kiln 2 enables both reduction of production costs and reduction of the ecological footprint.

Each primary circuit 11, 12 preferably comprises a first and a second internal exchanger 13, 14, the first exchanger 13 being arranged above a roller plane of the conveyor 5, and the second exchanger 14 being arranged below (see FIGS. 3 and 4).

To be precise, the plant 1 can be implemented on an already-existing kiln 2 or can be incorporated in the kiln 2 during production.

In the first case, the retrofitting of the kiln 2 can be actuated even if it includes the air/air exchanger of the prior art.

In fact, the first internal exchanger 13 of the invention can be arranged between the air/air exchanger and the ceiling of the vault of the kiln 2, the second internal exchanger 14 being in any case installable below the roller plane of the conveyor 5.

Therefore the invention also relates to a method for the recovery of heat from the cooling sections of a firing kiln 2 which includes a retrofitting of the kiln 2.

The primary circuits 11, 12 are completed by a thermodynamic device arranged externally of the kiln 2 which is preferably constituted either by a heat exchanger 3 (see FIG. 3) or by a thermal evaporator 4 (see FIG. 4).

In practice, each module of the kiln 2 will be associated to its own primary circuit 11, 12 which includes one or more internal exchangers fluid-dynamically connected to an external device which can be, by way of non-exclusive example, a further exchanger 3 or a thermal evaporator 4.

As can be seen in FIGS. 3 and 4, to each primary circuit 11, 12 are associated the safety devices necessary according to the sector standards relating to pressurised fluid, such as thermostats, safety valves, heat discharge valves, pressure switches, manometers, thermometers, or others besides (denoted in their entirety by reference numeral 15 in the appended design tables).

A circulation pump 16 is also present for the primary liquid, as well as an expansion tank 17 adequate for the maximum expansion of the chosen liquid.

In the preferred embodiment of the invention, shown in FIG. 1, the proposed plant 1 further includes a secondary circuit 18, external of the kiln 2, which associates the primary circuits 11, 12 in parallel.

In detail, the secondary circuit 18 is connected to the external exchangers 3 or the thermal evaporators 4 of the primary circuits 11, 12.

A secondary process fluid flows in the secondary circuit 18, which fluid is, for example, saturated steam, superheated steam, diathermic oil or superheated water.

In the example of FIG. 1, the plant 1 has been installed in the kiln 2 in such a way that the parallel connection of the secondary circuit 18 is achieved by grouping four primary circuits 11, 12 at a time, the outlet fluid from the first group (characterised by a lower temperature) entering the second group (where there is a higher temperature) and so on.

However, this is simply intended as a constructional example and is not limiting in character.

The same is true owing to the fact that the circuiting can be carried out with a three-tube system with inverse return, in order to balance the load losses; in this case too the choices of a merely constructional type can be made as a function of the specific applications.

Downstream of the plant 1 at least a user device is present, supplied by the secondary circuit 18.

The user device can be of the turbine type, such as an ORC group, i.e. having an organic-fluid Rankine cycle, or a steam turbine or even an absorption group.

Other types of user devices are however not excluded.

In the preferred embodiment, the plant 1 of the invention has been designed for the production of electrical energy for self-consumption.

Therefore, in the example of use of an ORC group, which can be activated either by liquid or a gaseous secondary fluid, according to the specific technology of the group itself, the proposed plant 1 is able to recover heat from the cooling sections of the kiln 2 (with all the inherent advantages already explained) then to be transformed into electrical energy in order to lower the very high consumption of the factories.

Further, the cooling water of the ORC groups, which acquires a temperature of approximately between 50° C. and 80° C., can be used, for example, for the environmental heating, with a further recovery of energy.

Likewise, the cited absorption group can be used for the production of electrical energy or for the environmental conditioning in the summer months.

Further, in a case in which the thermodynamic device of the first circuit is a thermal evaporator 4, the steam produced thereby can have further and different uses from the activation of the user devices.

In still greater detail, in order to give an idea of the flexibility and the multi-functionality of the plant 1, note that in output from the thermal evaporator 4 induced in a module of the plant 1, and thus associated to a module of the kiln 2, a saturated steam can be produced to activate the user device, as well as superheated steam sent to the secondary exchanger of a further module of the plant 1 itself.

1. A plant (1) for the recovery of heat from an industrial firing kiln (2), comprising at least one primary circuit (11, 12) that includes at least an internal heat exchanger (13, 14), arrangeable in a cooling section of said kiln (2), characterized in that it comprises at least a primary process liquid that flows in said primary circuit (11, 12).

2. The plant (1) according to claim 1, wherein said primary circuit (11, 12) comprises at least one external exchanger (3) which can be arranged externally of said kiln (2).

3. The plant (1) according to claim 1, wherein said primary circuit (11, 12) comprises at least one thermal evaporator (4) able to be arranged externally of said kiln (2).

4. The plant (1) according to claim 1, wherein said primary liquid comprises water that is superheated upon its passage in said exchanger.

5. The plant (1) according to claim 1, wherein said primary liquid comprises molten salts.

6. The plant (1) according to claim 2, comprising a secondary circuit (18) that is connected to said external exchanger (3) or to said an evaporator (4) of the primary circuit (11, 12).

7. The plant (1) according to claim 6, wherein a secondary process fluid flows in said secondary circuit (18), the secondary process fluid being selected from among: saturated steam, superheated steam, diathermic oil or superheated water.

8. The plant (1) according to claim 6, comprising a plurality of primary circuits (11, 12) associated in parallel by means of said secondary circuit (18).

9. The plant (1) according to claim 6, comprising at least one utilizer device that is supplied by the secondary circuit (18).

10. The plant (1) according to claim 9, wherein said utilizer device is a turbine type of device.

11. The plant (1) according to claim 9, wherein the utilizer device is an absorption unit.

12. A system for the recovery of heat, comprising a firing kiln (2) for ceramic items and a plant (1) according to claim 1, whose said internal heat exchanger (13, 14) is arranged in a cooling section of the kiln (2).

13. The system according to claim 12, wherein the primary circuit (11, 12) of the plant (1) comprises at least two internal exchangers (13, 14), a first internal exchanger (13) being arranged above a conveyor (5) for conveying ceramic items, which passes through said cooling section, and a second internal exchanger (14) being arranged below said conveyor (5).

14. The system according to claim 12, wherein the firing kiln (2) comprises a plurality of cooling sections, each of which being associated with a respective primary circuit (11, 12).

15. A method for recovering heat from a firing kiln (2) for firing ceramic items, comprising the following steps:
providing a firing kiln (2) comprising at least one cooling section;
providing at least one primary circuit (11, 12) that includes at least one internal heat exchanger (13, 14) wherein a primary process liquid flows;
mounting said internal exchanger (13, 14) within said cooling section; and
collecting said primary liquid that has been heated by passage in the exchanger.
